(19) United States
(12) Patent Application Publication
(10) Pub. No.: US 2014/0091051 A1
(43) Pub. Date: Apr. 3, 2014

(54) DISPLAY FIXTURE FOR HIGHLIGHTING PRODUCTS

(71) Applicant: S.C. JOHNSON & SON INC., Racine, WI (US)

(72) Inventor: Pablo Javier Battilana, Buenos Aires (AR)

(73) Assignee: S.C. JOHNSON & SON INC., Racine, WI (US)

(21) Appl. No.: 13/632,852

(22) Filed: Oct. 1, 2012

(51) Int. Cl. G09F 19/00

(52) U.S. Cl. 211/119.003

(57) ABSTRACT

A highlighter assembly for attracting and centering consumer's attention on a group of products displayed in a retail setting. The highlighter assembly has a frame and an interface assembly for coupling the frame to the display structure. The frame includes a plurality of extendable straight modules, each of the extendable straight modules having a smaller profile piece telescoping within a wider piece. Both pieces having a front side and a back side, wherein the back side defines an elongated slot. The frame also includes at least one corner module with a front side and a back side. The back side of the corner module defines an elongated slot. The straight and corner modules connect to form a viewing space about a group of products on a display structure.

### BACKGROUND OF THE DISCLOSURE

1. Field of the Disclosure

The subject disclosure relates to assemblies for displaying products, and more particularly to an assembly that highlights certain products in a retail setting.

2. Background of the Related Art

Typically, retail stores are arranged with a series of aisles that run from the front to the back of the store. As the aisles can be quite long, signs are typically used to list the products contained in the aisle. As for the various products, they are simply loosely grouped. Thus, as one walks down the aisle, the items continuously run from one various product grouping to another and from one brand to another within the product groupings. The overall effect for the consumer can be one of dizzying confusion and difficulty in finding a particular item. From the retailer's perspective, additional sales are often lost because the consumer does not easily see related products as a group.

Techniques for enhancing product display do exist. Some examples are illustrated in U.S. Pat. No. 7,810,658 issued to Clark et al. on Oct. 12, 2010, U.S. Pat. No. 7,757,418 issued to Clark et al. on Jul. 20, 2012, and U.S. Patent Application Pub. No. 2010/0044326 published in the name of Meyer-Hanover et al. on Feb. 25, 2010, each of which is incorporated herein by reference.

### SUMMARY OF THE INVENTION

Despite the advances of the state of the art in display assemblies, drawbacks and shortcoming still exist. The prior art systems are typically a unique assembly not suited for adaptation across various aisle platforms. Other systems are stand alone fixtures that interrupt aisle space and flow, which is a critical drawback in aisles crowded with shopping cart. Further, these systems do not draw a consumer's attention to sub groups of products within the display. It would also be desirable for the systems to adapt to the particular space in which the product grouping exists.

The subject technology solves these and other problems by being modular, adjustable and adaptable. The subject technology provides an assembly that can be adapted to various existing structure and scaled up or down according to particular applications. The assembly can also be harmonized with various other items such as are typically used to present a cohesive branded product display. A complete display assembly can be manufactured on a large scale and yet meet the needs of many different retailers and retail applications. As a result, there is a cost savings that can be passed along to retailers and consumers.

The subject technology is directed to a highlighter assembly for attracting and centering consumer's attention on a group of products displayed in a retail setting. The highlighter assembly has a frame including extendable straight modules. The number of straight modules may be as few as one or an unlimited number but from four to ten would be typical. Some or all of the extendable straight modules can have a smaller profile piece telescoping within a larger profile piece. The smaller and larger profile pieces have a front side and a back side, of which the back side may define an elongated slot. The frame also has one or more corner modules, typically four corner modules so that the viewing area may be an enclosed rectangle. The corner module has a front side and a back side of which the back side may define an elongated slot. The straight and corner modules connect to form the viewing area about a group of products on a display structure. An interface assembly couples the enclosed frame to the display structure. The interface assembly may include one or more bracket assemblies, each bracket assembly including a first end adapted to engage the display structure, and a second end adapted to engage the elongated slots. In some embodiments, the highlighter assembly includes at least one expandable window sized to fit within the viewing area for emphasizing a sub-group of the products.

Another embodiment of the subject technology is directed to a highlighter assembly for attracting and centering consumer's attention on a group of products displayed in a retail setting including a frame and an interface assembly for coupling the enclosed frame to the display structure. The frame includes at least two straight modules having a front side and a back side, and at least one corner module having a front side and a back side. At least one of the straight modules or corner module has a first piece connected to at least one second piece such that the straight modules and the corner module connect to form an adjustable viewing space about a group of products on a display structure. At least one of the back side of the straight modules or corner modules defines an elongated slot. The interface assembly includes a first portion adapted to engage the display structure, and a second portion adapted to engage the elongated slot.

The first piece and the at least one second piece of the straight modules or corner module may be configured with complimentary male and female ends such as smaller profile pieces telescoping within a wider pieces or snap-fit arrangements. A plurality of clamp assemblies may couple the enclosed frame to a shelf of the display structure. The clamp assemblies are selected from the group consisting of: a C shaped bracket defining first and second threaded holes; a shelf screw for engaging the shelf through the first hole; and a module screw assembly for engaging the module through the second hole and the respective elongated slot. The corner modules may be extendable and the back side thereof can define an elongated slot. The straight modules may also be extendable by having a smaller profile piece telescoping within a larger profile piece and the back side thereof can also define an elongated slot with a plurality of bore holes. The interface assembly can include an extendable middle portion between the first and second portions. At least one expandable window can also be included with the frame for emphasizing a sub-group of the products.

Still another embodiment is directed to a display fixture for attachment to a retail fixture including a plurality of frame elements. The frame elements have a first end and a second end, wherein the first end of a frame element is telescopingly interactive with the second end of a different frame element to form an enclosed frame. The enclosed frame may be adjustable. One or more bracket supports interacting with a shelf of the retail fixture and a back of the enclosed frame to support the frame. One or arm supports interact with a back wall of the retail fixture and the back of the enclosed frame to support the frame as well. At least one expandable window may be included within the enclosed frame for emphasizing a sub-group of the products.

Another embodiment is directed to a highlighter assembly for attracting and centering consumer's attention on a group of products displayed in a retail setting. The highlighter assembly has a frame and an interface assembly for coupling the frame to the display structure. The frame includes a plurality of extendable straight modules, each of the extendable straight modules having a smaller profile piece telescoping within a wider piece. Both pieces having a front side and a back side, wherein the back side defines an elongated slot. The frame also includes at least one corner module with a front side and a back side. The back side of the corner module defines an elongated slot. The straight and corner modules connect to form a viewing space about a group of products on a display structure.

The interface assembly can include a first end adapted to engage the display structure and a second end adapted to engage the elongated slots. The first end of the interface assembly can be at least one bracket assembly adapted to engage the display structure consisting of the group of a shelf, a slat wall, a perforated wall, a top of a wall and combinations thereof. At least one expandable window within the frame for emphasizing a sub-group of the products. The frame may enclose the group of products. Interface plates may be mounted to one or more of the straight modules or the corner modules, wherein the interface plates define a slot aligned with the respective elongated slot. A placard may be secured to a gap formed between the respective module and interface plate, such placard may contain advertising, branding, instructions and like graphics.

In another embodiment, the subject technology is a kit that includes the components as recited in the originally filed claims and combinations thereof. The kit may be bagged, boxed, or otherwise collected for shipment, display and sale.

It should be appreciated that the present technology can be implemented and utilized in numerous ways, including without limitation as a process, an apparatus, a system, a device, a structure, and a method for applications now known and later developed. These and other unique features of the technology disclosed herein will become more readily apparent from the following description and the accompanying drawings.

### BRIEF DESCRIPTION OF THE DRAWINGS

So that those having ordinary skill in the art to which the disclosed technology appertains will more readily understand how to make and use the same, reference may be had to the following drawings.

FIG. 1 is a perspective view of a highlighter assembly in accordance with the subject technology in a retail environment.

FIG. 2 is an enlarged perspective view of a corner module and a straight module of a highlighter assembly in accordance with the subject technology.

FIG. 3 is a rear exploded perspective view of a highlighter assembly in accordance with the subject technology showing the slotted modules along with screws and a C clamp for attachment to a shelf.

FIG. 4 is a side elevation view of a highlighter assembly, taken at cut-line 4-4 of FIG. 1, showing the frame installed on a shelf.

FIG. 5 is a side elevation view of a highlighter assembly in accordance with the subject technology but showing an alternative extension bracket.

FIG. 6 is a perspective view of another highlighter assembly in accordance with the subject technology, showing a large shelf at the top, and an extension bracket back to wall securing the vertical member.

FIG. 7 is a rear perspective view of the corner member, and portions of the vertical and horizontal members of the highlighter assembly of FIG. 6 with the C clamp and extension bracket shown adjacent, with nuts to be received in larger apertures.

FIG. 8 is a rear perspective view of the highlighter assembly, taken at circle 8 of FIG. 7, showing the C-clamp assembly being attached to the corner module.

FIG. 9 is a perspective view of the extension bracket of the highlighter assembly of FIG. 6 with three options shown for securing the frame to various support wall types.

FIG. 10 is a sectional elevation view of C clamp assembled to the shelf and frame of the highlighter assembly of FIG. 6.

### DETAILED DESCRIPTION OF PREFERRED EMBODIMENTS

The present disclosure overcomes many of the prior art problems associated with displays for drawing attention to various products and groups of products. The present disclosure is particularly useful for highlighting one or more products in a retail aisle. The advantages, and other features of the technology disclosed herein, will become more readily apparent to those having ordinary skill in the art from the following detailed description of certain preferred embodiments taken in conjunction with the drawings which set forth representative embodiments of the present invention and wherein like reference numerals identify similar structural elements.

All relative descriptions herein such as left, right, up, and down are with reference to the Figures, and not meant in a limiting sense. Additionally, for clarity common items such as screws and rivets have not been included in the Figures as would be appreciated by those of ordinary skill in the pertinent art. Unless otherwise specified, the illustrated embodiments can be understood as providing exemplary features of varying detail of certain embodiments, and therefore, unless otherwise specified, features, components, modules, elements, and/or aspects of the illustrations can be otherwise combined, interconnected, sequenced, separated, interchanged, positioned, and/or rearranged without materially departing from the disclosed systems or methods. Additionally, the shapes and sizes of components are also exemplary and unless otherwise specified, can be altered without materially affecting or limiting the disclosed technology.

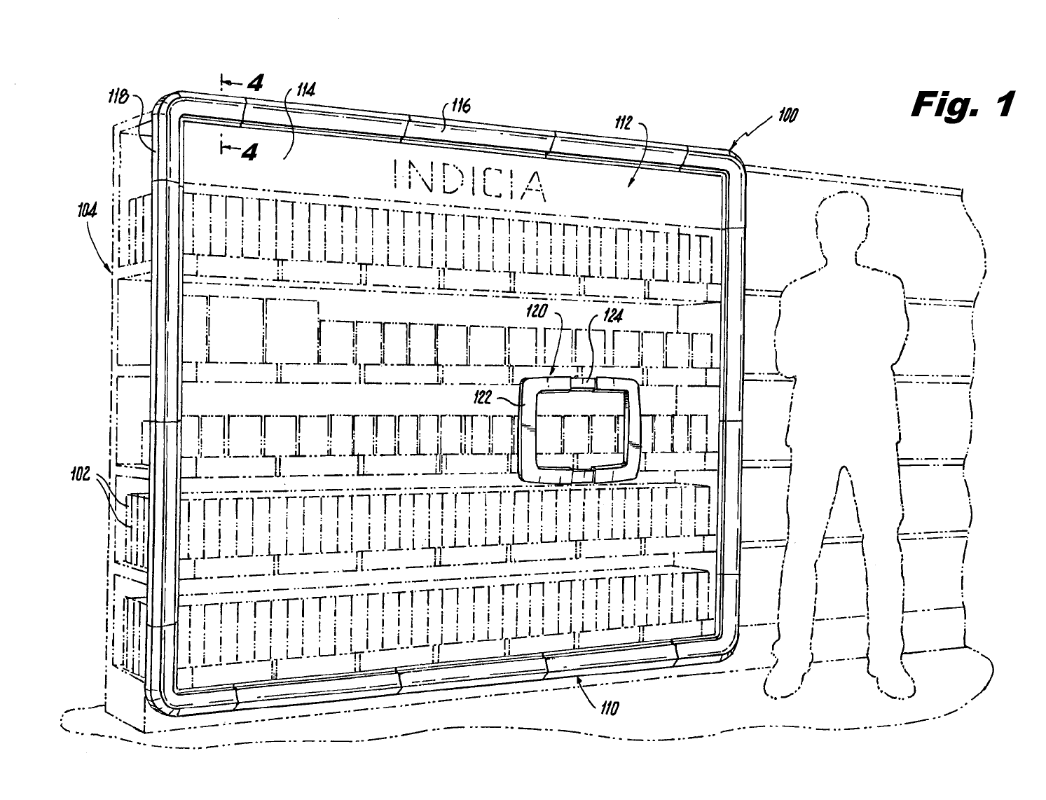

Now referring to FIG. 1, a perspective view of a highlighter assembly 100 in accordance with the subject technology is shown in a retail environment. The highlighter assembly 100 breaks up an otherwise uninterrupted aisle to attract and center a consumer's attention on a group of products 102 displayed on a retail shelf structure 104. The products 102 are placed on a normal shelf structure 104 in a normal manner while the highlighter assembly 100 couples to the shelf structure 104 without interfering with access to the products 102. As a result, there is improved sales impact upon the highlighted products.

The highlighter assembly 100 includes a frame 110 that defines a viewing space 112. Creation of the viewing space 112 demarcates the products therein and interrupts the consumer's attention so the eye is drawn into the viewing space 112. The frame 110 can also accept various placards 114, inside and outside the frame 110 at any point of any size. The placards 114 presents information, trademarks, imagery and other indicia associated with the products 102. The placards 114 may also be illuminated for enhanced visual impact.

The frame 110 includes a plurality of straight modules 116 interconnected with four corner modules 118. In some embodiments, the modules 116, 118 are extendable so that by varying the number of straight modules 116 and size of the modules 116, 118, the viewing space 112 can be any size rectangle. In addition to placards 114 and other items within the viewing space, coupon dispensers, sample dispensers, instruction packets, and other branded and non-branded information can be included. In centimeters, exemplary sizes for the frame 110 are 60×60, 75×75, 60×110, 75×140, 110×110, 160×160, 160×110, 210×140, 210×160, and 270×210.

The viewing space 112 also includes an innovation window 120. The window 120 further emphasizes a sub-group of products 102 or draws attention to a related display such as product samples, new product offerings, product variations, or complimentary products and the like. The window 120 may be two C-shaped side modules 122 interconnected by two smaller profile straight modules 124. The straight modules 124 may also telescope within the side modules 122 so that the innovation window 120 is also expandable at least in width. The manner in which the innovation window 120 attaches to the shelf structure 104 and/or expands may be the same as the frame 110 as discussed below. As the innovation window 120 is smaller, the innovation window may simply be set in place by a temporary adhesive, clips and the like.

The innovation window 120 may also be formed from more components so that the size may be expanded or reshaped from time to time in a manner similar to the frame 110 as discussed below. It is also envisioned that the frame 110 and the window 120 may include indicia such as a brand or other information and graphics. The innovation window 120 may also simply contain a picture, branding information, coupons and/or like information.

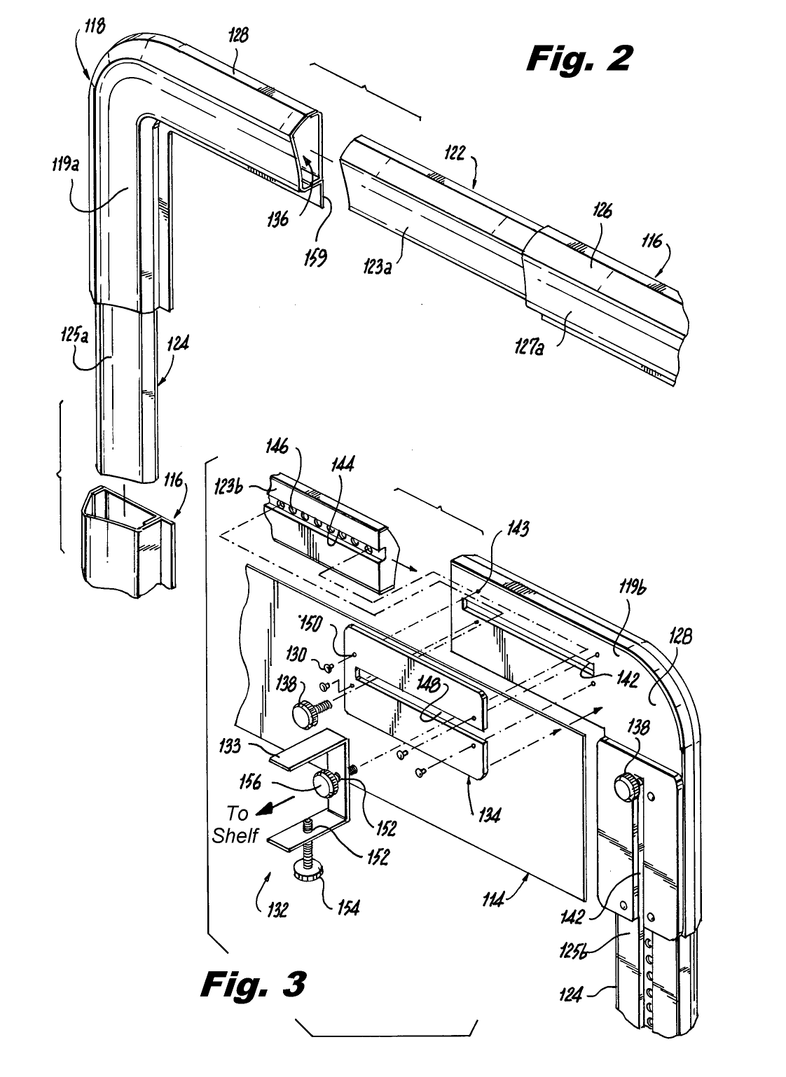

Referring now to FIG. 2, an enlarged perspective view of a corner module 118 and a straight module 116 of a highlighter assembly 100 in accordance with the subject technology is shown. Each of the modules 116, 118 includes smaller profile pieces 122, 124, respectively, telescoping within wider pieces 126, 128. The pieces 122, 124, 126, 128 may all have the same profile and connect by snap fit such as with toy train tracks, end flanges with screws, various male protrusions that are captured within complimentary female voids such as with LEGO building block or k'nex kits available from lego.com and knex.com, respectively, and the like. Thus, the modules 116, 118 may be of varying lengths and designed to interconnect so that any desired shape frame can be accomplished using a variety of very short, short, medium, large and very large modules 116, 118. The front side or face 119a, 123a, 125a, 127a of the modules 116, 118 may be any color and is substantially smooth to present a substantially uniform frame 110. As can be seen, four corner modules 118 could be used to form an innovation window 120.

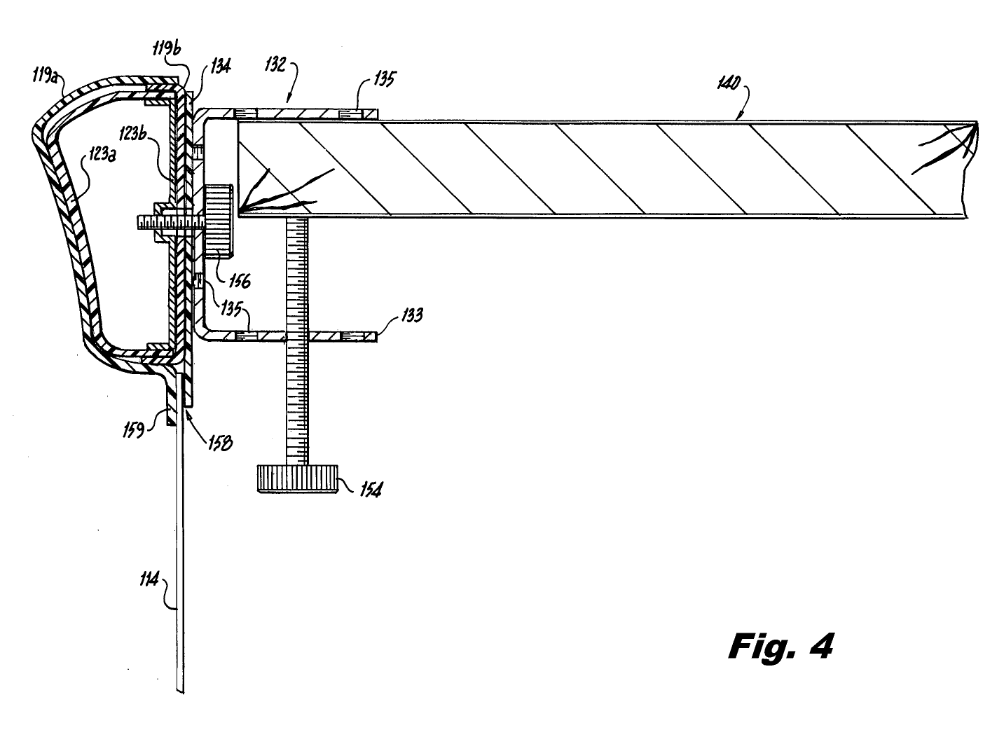

Referring additionally to FIG. 3, a rear exploded perspective view of a corner area of the highlighter assembly 100 of FIG. 2 is shown. The back sides 119b, 123b, 125b, 127b of the modules 116, 118 define various structures to interface with fasteners 130, 138, a C-clamp assembly 132, and an optional interface plate 134 for attachment to a shelf 140 (see FIG. 4) of the shelf structure 104. The front sides 119a, 127a and the back sides 119b, 127b of the larger profile pieces 126, 128 could be separately formed and coupled together or formed as a unitary pieces as is known to those of ordinary skill in the art. As best seen in FIGS. 2 and 4, the larger profile pieces 126, 128 form enclosed channels 136 that receive the smaller profile pieces 122, 124, which are shown formed of two parts and hollow but may also be solid.

Although the following description is with respect to the back side 119b of the large profile piece 128 of a corner module 118 and the back side 123b, 125b of smaller profile pieces 122, 124, the arrangement can be swapped, interchanged and otherwise varied as would be appreciated upon review of the subject disclosure. The back side 119b of the corner module 118 forms two elongated slots 142, which may be open or closed, along with mounting holes 143. The back sides 123b, 125b form channels 144 having a plurality of threaded bores 146.

Still referring to FIG. 3, the interface plate 134 also defines an elongated slot 148 along with mounting holes 150. The C-clamp assembly 132 has a C-shaped bracket 133 that defines two threaded bores 152 that receive two screws 154, 156, which are capped so that one can easily turn the screws 154, 156 by hand. The C-shaped bracket 133 may also include several additional holes 135 that allow varying the placement of the screws 154, 156 to adapt to varying display shelves.

Referring additionally to FIG. 4, a side elevation view of the highlighter assembly 100, taken at cut-line 4-4 of FIG. 1, is shown, wherein the frame 110 is installed on a shelf 140. When assembled, the smaller profile pieces 122, 124 are inserted into the respective enclosed channel 136 so that the channels 144 align with the elongated slot 142. Once the frame 110 is laid out to the desired size, a plurality of fasteners 138 are used to pass through the slot 142 and into one of the threaded bores 146 to rigidly fix the components together.

The optional interface plate 134 is riveted or screwed to the corner module 118 using fasteners 130 passing into bores 143, 150. The optional interface plate 134 can also be captured and secured by the fasteners 138 passing through the slot 148. In some embodiments, the frame 110 has an inner lip 159. Using the optional interface plate 134 creates a gap 158 with the inner lip 159 of the modules 116, 118 into which the placard 114 can be securely fit and retained. As such, placards 114 of various sizes, shapes and orientations can be coupled to the frame 110 at any desired location.

Still referring to FIG. 4, in order to couple the frame 110 to the shelves 140, one or more C-clamp assemblies 132 are used. It is envisioned that the C-clamp assembly 132 can couple to both horizontal and vertical portions of the frame 110. First, the C-clamp assembly 132 is coupled to the frame 110 by threading the screw 156 into a bore 146 through the bracket 133, interface plate 134, and corner module 118. Then, once the frame 110 is properly positioned with the brackets 133 resting on the shelves 140, the screws 154 are tightened to secure the C-clamp assemblies 132 and, thereby, the frame 110 in place.

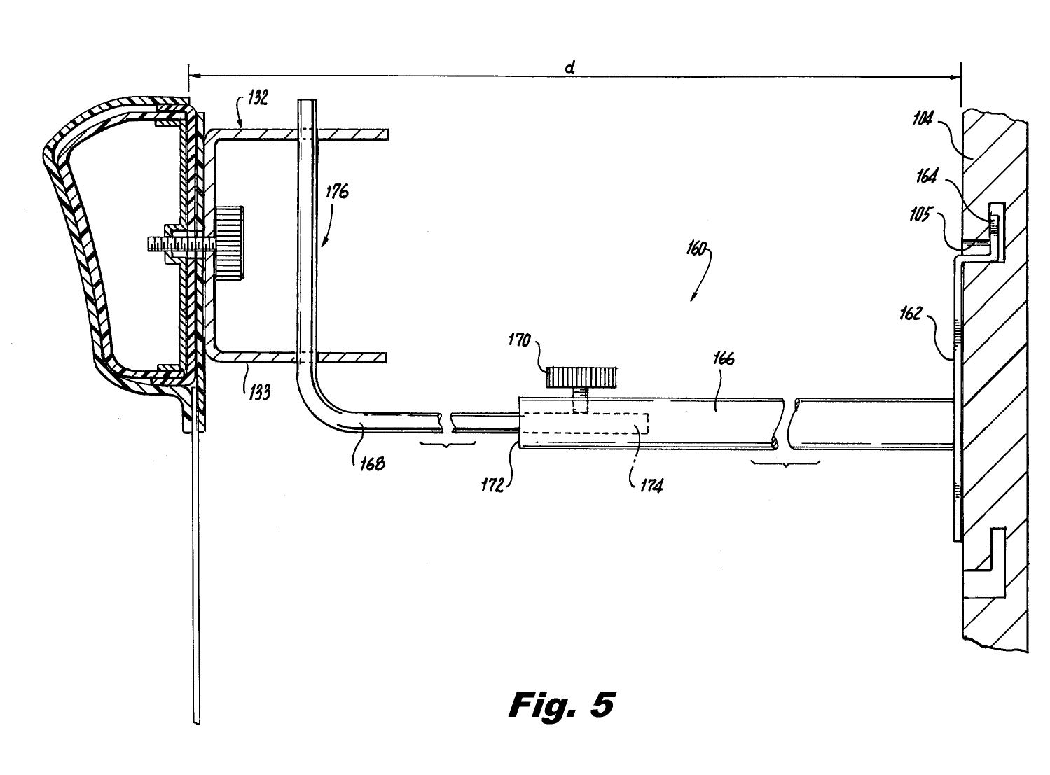

Referring now to FIG. 5, a side elevation view of the highlighter assembly 100 is shown assembled with an alternative extension bracket assembly 160 particularly suited for use with displays 104 that do not utilize shelves. Such displays 104 typically form slots 105 (as shown) or holes and the like, to which fixtures mount for displaying products. Often, the products 102 in such displays are either packaged in bags or boxes that form a hang tag for sliding over a post mounted on a slat wall of the display or simply have a hang tag affixed directly to the product 102 itself.

The bracket assembly 160 includes a back plate 162 adapted and configured with a bent portion 164 to engage the slot 105 in the slat wall of the display 104. A post 166 extends from the back plate 162 and includes a knurled screw 170 near the distal end 172. The post 166 and hook 168 may be circular, triangular, square and the like in cross-section.

An L-shaped hook 168 has a proximal end 174 that inserts into the distal end 172 of the post 166 so that the L-shaped hook 168 is secured rigidly in place by the knurled screw 170. A distal end 176 of the L-shaped hook 168 acts as a hanging peg onto which the bracket 133 of the C-clamp assembly 132 snugly fits. Thus, by using a plurality of bracket assemblies 160, the frame 110 may be coupled to the display 104. The lengths of the post 166 and proximal end 174 are such that the proximal end 174 may telescope within the post 166 to set a variable distance “d” that the frame 110 mounts from the display 104. It is also envisioned that bracket assemblies 160 can be used with C-clamp assemblies 132 to increase the locations and robustness of mounting the frame 110.

As can be seen from the description above, the frame 110 of the highlighter assembly 100 is adjustable to any desired height and width using the telescoping features of the modules 116, 118. Further, the modules 116, 118 do not need to align with shelves as the bracket assemblies can be mounted, for example, simply on a lower half of the frame 110, while still providing ample support to the entire frame 110. In such a case, the frame 110 may extend well above the height of the display structure. Depending upon the final arrangement of the pieces 122, 124, 126, 128, the smaller profile pieces 122, 124 would be readily seen in the frame 110. In one assemblage, an equal portion of the smaller profile pieces 122, 124 may be seen at every seam as opposed to another assemblage where a large portion of just two opposing smaller profile pieces 122, 124 is shown at a less conspicuous location such as at or near the bottom.

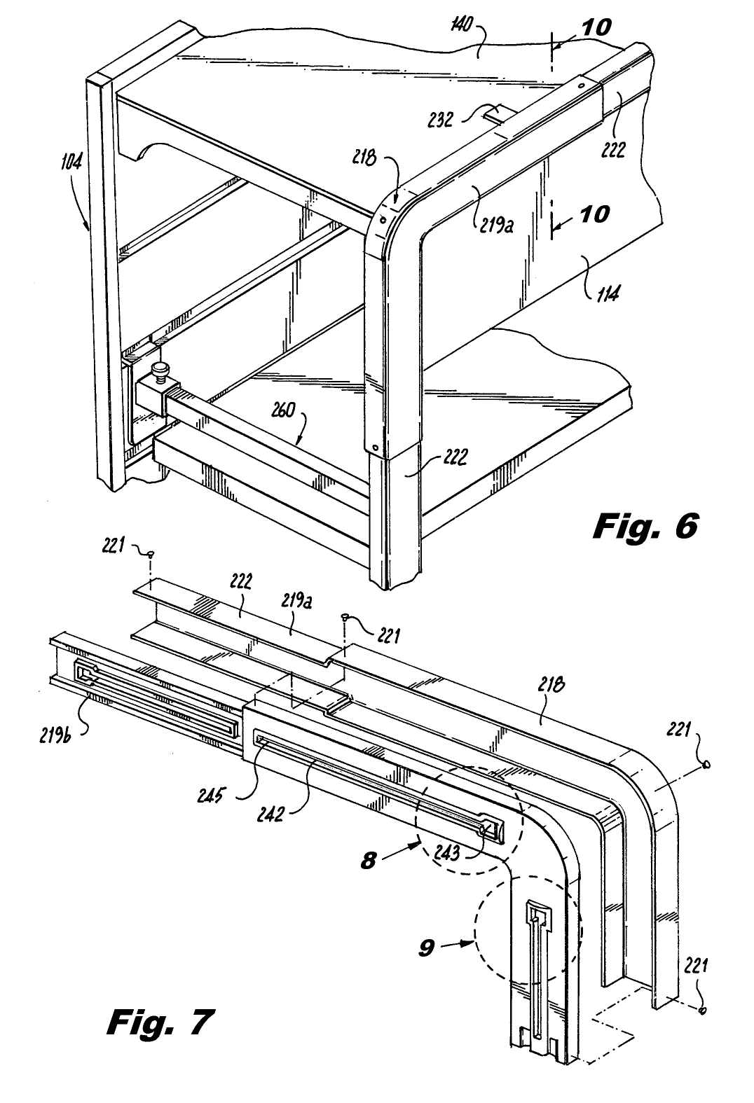

Referring now to FIG. 6 is a perspective view of another highlighter assembly 200 in accordance with the subject technology. The highlighter assembly 200 is coupled to the display 104 by engaging shelves 140 as shown at the top (and bottom) using C-shaped bracket assemblies 232 and by using extension bracket assemblies 260 along the sides. As will be appreciated by those of ordinary skill in the pertinent art, the assembly 200 utilizes similar principles to the assembly 100 described above. Accordingly, like reference numerals preceded by the numeral “2” instead of the numeral “1”, are used to indicate like elements. The primary difference of the assembly 200 in comparison to the assembly 100 is the configuration of the back side of the frame 210. As such, for brevity, the following description is directed principally to this and other differences.

Referring now to FIG. 7, a rear perspective exploded view of the corner module 218 of the highlighter assembly 200 is shown. The corner module 218 includes a front portion 219a that is coupled to a back portion 219b by fasteners 221. In the embodiment shown, the fasteners 221 are rivets but may also be hot melt points, adhesive, screws and the like. The ends 222 of the corner module 218 are necked down for telescoping within a straight module 216. The back portion 219b defines slots 242 for capturing the C-clamp assemblies 232. The slots 242 have at least one enlarged end 243 to facilitate engagement with the C-clamp assemblies 232.

Referring now to FIG. 8, a rear perspective view of the corner module 218 assembly, taken at circle 8 of FIG. 7, is shown. The C-clamp assembly 232 is shown being attached to the corner module 218. The C-clamp assembly 232 has a fastener 256 modified to include a nut 257. The nut 257 is sized and shaped to pass through the enlarged end 243 of the slot 242 but be captured in the narrower remainder 245 of the slot 242. As a result, the nut 257 can be inserted into the slot 242 and slid to a desired location. The fastener 256 can then be tightened to fix the C-clamp assembly 232 to the corner module 218 as shown in dashed lines in FIG. 8 and in cross-section in FIG. 10. A similar arrangement and attachment method can be used for the straight modules 216. Once the C-clamp assembly 232 is fixed to the frame 210, the fastener 254 can then be tightened to fix the C-clamp assembly 232 and, thereby the frame, to the shelf 140. It is envisioned that each module 216, 218 will have a plurality of slots 242 in order to allow flexibility and ease in assembling the frame 210.

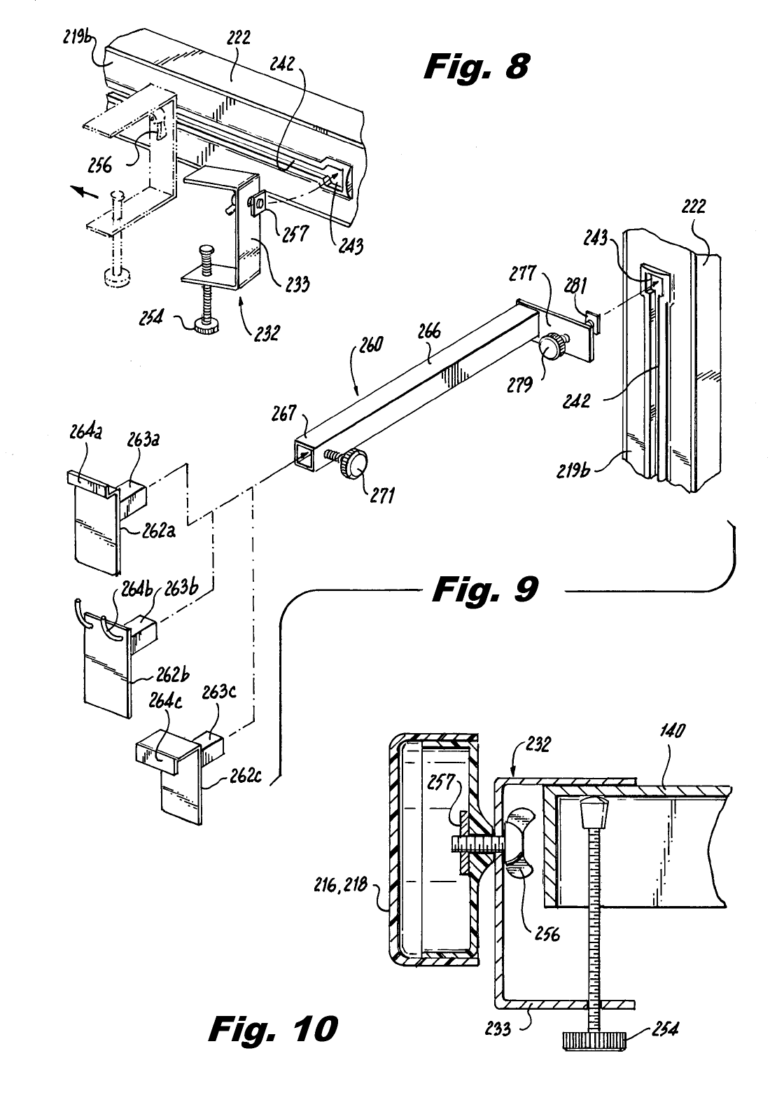

Referring now to FIG. 9, a perspective view of an extension bracket 260 of the highlighter assembly 200 is shown with three options shown for securing the frame 210 to various support wall types. The extension bracket 260 has a square tubular central post 266 with a proximal end 267 adapted with a set screw 271 for securing one of the wall adapter 262a, 262b, 262c. Each wall adapters 262 has a post 263 that is sized and configured to be inserted into the central post 266 and fixed in place by the set screw 271. The post 263 may also be elongated to allow varying the length of the extension bracket 260. The wall adapter 262a has an upwardly bent portion 264a for attaching to a slat wall (not shown). The wall adapter 262b has two prongs 264b for attaching to a perforated wall. The wall adapter 262c has a downward bent portion 264a for hanging on a complimentary structure such as a slat wall, square bar or the top of a wall.

A distal end 276 of the extension bracket 260 is also adapted to engage the slot 242 of the modules 216, 218. The distal end 276 includes a perpendicularly mounted plate 277 for holding a hand screw 279 and nut 281. By inserting the nut 281 into the slot 242 and tightening the screw 279, the extension bracket 260 can be coupled to the frame 210. By coupling various combinations of C-clamp assemblies 232 and/or extension brackets 260 at varying positions of the frame 210, the frame 210 is very robustly mounted.

As would be appreciated by those of ordinary skill in the pertinent art, the subject technology is applicable to use in virtually any retail setting. The highlighter assemblies can adapt to a plurality of existing display structures and be varied in size to suit particular applications. The modules do not need to align to the shelves but can be supported by a variety of brackets, which can vary the distance to the display structure. Further, since the frame is rigid once connected, as few as one bracket may be used to support the frame. For example, in some embodiments, the highlighter assembly may be provided such that the lower half of the assembly is juxtaposed against an adjacent shelving unit and the upper half of the assembly may extend above the shelving unit. Because of the structure of the assembly (including, among other things, one or more C-clamps), the assembly is able to be secure and upright in such a position as opposed to other structures that do not have such structure.

The subject technology is modular and lends itself to simply increasing or decreasing the number of components to accomplish different goals. Thus, production of the assemblies can be for a single item yet every vendor will be able to utilize the product in specialized application. The highlighter assemblies may extend up well above the normal display height or even be utilized on part or all of an end cap. The frame also need not enclose the viewing space. Rather, the frame could underscore, bracket, or simply partially frame the group of products in a uniform or non-uniform shape (e.g., a O, U, D, Z, H, T, Y, E, V, N, L and the like shapes). Thus, the highlighter assemblies may be adapted and configured to enclose a relatively smaller viewing area than shown in FIG. 1 or a larger area, while still providing easy assembling and improved impact of the products upon the consumer.

The functions of several elements of the highlighter assemblies may, in alternative embodiments, be carried out by fewer elements, or a single element or many more elements than shown. Similarly, in some embodiments, any functional element may perform fewer, or different, operations than those described with respect to the illustrated embodiment. Functional elements (e.g., screws, nuts, rivets, brackets, hooks, modules and the like) shown as distinct for purposes of illustration may be incorporated within other functional elements, separated in different hardware or distributed in various ways in a particular implementation. Further, relative size and location are merely somewhat schematic and it is understood that not only the same but many other embodiments could have varying depictions. The frame of the highlighter assemblies may even be open, yet still effectively define a viewing area.

The subject technology can also be provided as a kit. The kit could include various straight and corner modules along with the placards and other graphics, brackets, clamp assemblies, innovation windows and the like to make any number of various configurations. It is also envisioned that the elements can be customized with various shapes and branding to be specific to a particular product or group of products or be more general for applicability to a large variety of products. For example, the corner modules may not be right angles so that various shapes other then rectangles may be formed such as trapezoids, triangles, pentagons, hexagons, septagons, octagons and the like or even irregular shaped viewing areas.

The subject technology may also be incorporated within a figure of merit that rates the suitability and/or performance of retail locations. The figure of merit may include a plurality of categories particular to specific retail locations such as pharmacies, supermarkets, convenience stores etc. The categories may pertain to items such as how the entrance of the store looks, the location, the checkout area configuration, placement of items on the shelf such as whether or not highlighter assemblies in accordance with the subject technology are used, and the like. These factors may be weighted or unweighted but, in either case, once compiled the result is an overall figure of merit that indicates the desirability and/or performance of a particular retail location. It is envisioned that such data would be entered into a computer for storage in local memory. A processor would communicate with the memory and run an instruction set the generates the figures of merit upon entry of the related data. The categories may also be a checklist where the computer indicates percentage complete or groups the retail locations into tiers.

While the invention has been described with respect to preferred embodiments, those skilled in the art will readily appreciate that various changes and/or modifications can be made to the invention without departing from the spirit or scope of the invention. For example, each claim may depend from any or all claims, even in a multiple dependent manner, even though such has not been originally claimed.

What is claimed:

1. A highlighter assembly for attracting and centering consumer's attention on a group of products displayed in a retail setting comprising:
a) a frame including:
at least two modules having a front side and a back side,
wherein: at least one of the modules has a first piece connected to at least one second piece such that the modules connect to form an adjustable viewing space about a group of products on a display structure; and at least one of the back side of the modules defines an elongated slot; and
b) an interface assembly for coupling the frame to the display structure, the interface assembly including a first portion adapted to engage the display structure, and a second portion adapted to engage the elongated slot.

2. A highlighter assembly as recited in claim 1, wherein the first piece and the at least one second piece of the modules are configured with complimentary male and female ends and the frame encloses the viewing space.

3. A highlighter assembly as recited in claim 2, wherein the first piece and the at least one second piece of the modules are a smaller profile piece telescoping within a wider piece.

4. A highlighter assembly as recited in claim 1, wherein the interface assembly comprises a plurality of clamp assemblies for coupling the frame to a shelf of the display structure.

5. A highlighter assembly as recited in claim 4, wherein the clamp assemblies are selected from the group consisting of: a C shaped bracket defining first and second threaded holes; a shelf screw for engaging the shelf through the first hole; a module screw assembly for engaging the module through the second hole and the respective elongated slot; and combinations thereof.

6. A highlighter assembly as recited in claim 1, wherein the modules include straight modules and corner modules that are extendable and the back side thereof defines an elongated slot.

7. A highlighter assembly as recited in claim 1, wherein the modules are extendable by having a smaller profile piece telescoping within a larger profile piece and the back side of the smaller piece defines an elongated slot with bore holes therein.

8. A highlighter assembly as recited in claim 1, wherein the interface assembly includes an extendable middle portion between the first and second portions.

9. A highlighter assembly as recited in claim 1, further comprising at least one emphasis window within the frame for emphasizing a sub-group of the products and wherein the frame is enclosed.

10. A display fixture for attachment to a retail fixture comprising:
a) a plurality of frame elements having a first end and a second end, wherein the first end of a frame element is telescopingly interactive with the second end of a different frame element;
wherein the plurality of frame elements are telescopingly interacted such that the plurality of frame elements form an enclosed frame; and
(b) one or more bracket supports for interacting with a shelf of the retail fixture and a back of the enclosed frame.

11. A display fixture as recited in claim 10, further comprising at least one expandable window within the enclosed frame for emphasizing a sub-group of the products and one or more arm supports for interacting with a back wall of the retail fixture and the back of the enclosed frame.

12. A highlighter assembly for attracting and centering consumer's attention on a group of products displayed in a retail setting, the highlighter assembly comprising:
a) a frame including:
a plurality of extendable straight modules, each of the extendable straight modules having a smaller profile piece telescoping within a wider piece, both pieces having a front side and a back side, wherein the back side defines an elongated slot;
at least one corner module, each corner module having a front side and a back side, wherein the back side defines an elongated slot, wherein the straight and corner modules connect to form a viewing space about a group of products on a display structure; and
b) an interface assembly for coupling the frame to the display structure.

13. A highlighter assembly as recited in claim 12, wherein the interface assembly has a first end adapted to engage the display structure and a second end adapted to engage the elongated slots.

14. A highlighter assembly as recited in claim 13, wherein the first end of the interface assembly is at least one bracket assembly adapted to engage the display structure consisting of the group of a shelf, a slat wall, a perforated wall, a top of a wall and combinations thereof.

15. A highlighter assembly as recited in claim 12, further comprising at least one expandable window within the frame for emphasizing a sub-group of the products and wherein the frame is enclosed.

16. A highlighter assembly as recited in claim 12, further comprising at least one interface plate mounted to at least one of the straight modules or the at least one corner module, wherein the at least one interface plate defines a slot aligned with the respective elongated slot.

17. A highlighter assembly as recited in claim 16, further comprising a placard secured to a gap formed between the respective module and interface plate.
